(19) United States
(12) Patent Application Publication
(10) Pub. No.: US 2026/0196393 A1
(43) Pub. Date: Jul. 9, 2026

(54) Sm-Fe-N MAGNET

(71) Applicant: Murata Manufacturing Co., Ltd., Nagaokakyo-shi (JP)

(72) Inventors: Takaaki YOKOYAMA, Nagaokakyo-shi (JP); Noriyuki NOZAWA, Nagaokakyo-shi (JP); Takashi OYAMA, Nagaokakyo-shi (JP)

(21) Appl. No.: 19/554,897

(22) Filed: Mar. 3, 2026

Related U.S. Application Data
(63) Continuation of application No. PCT/JP2024/033524, filed on Sep. 19, 2024.

(30) Foreign Application Priority Data
Sep. 29, 2023 (JP) 2023-170759

(51) Int. Cl. H01F 1/059

(52) U.S. Cl. CPC H01F 1/059

(57) ABSTRACT

A Sm—Fe—N magnet that includes: first crystal grains containing samarium, iron, and nitrogen and having a samarium content of 9 atomic % or more and less than 13 atomic %; and second crystal grains having a samarium content of 13 atomic % or more, wherein, in the second crystal grains, a first average distance between adjacent grains at a cumulative frequency of 50% is 7 μm or less, and a second average distance between adjacent grains at a cumulative frequency of 90% is 12 μm or less.

### CROSS REFERENCE TO RELATED APPLICATIONS

The present application is a continuation of International application No. PCT/JP2024/033524, filed Sep. 19, 2024, which claims priority to Japanese Patent Application No. 2023-170759, filed Sep. 29, 2023, the entire contents of each of which are incorporated herein by reference.

### TECHNICAL FIELD

The present disclosure relates to a Sm—Fe—N magnet.

### BACKGROUND ART

Sm—Fe—N magnets are representative of rare earth-transition metal-nitrogen magnets, and they exhibit high anisotropic magnetic field and remanence. Additionally, due to their relatively high Curie temperature compared with other rare earth-transition metal-nitrogen magnets, they exhibit excellent heat resistance. As a result, Sm—Fe—N crystalline grains have been used as one of the excellent materials for magnet powders. On the other hand, Sm—Fe—N magnets are known to be prone to undergo a decrease in coercivity when subjected to heat treatment.

Accordingly, Patent Document 1 discloses a Sm—Fe—N magnet that is a magnet powder in which the surface of the main phase containing samarium and iron is covered with a secondary phase having a higher rare-earth element content.
Patent Document 1: International Publication No. 2019-189440

### SUMMARY OF THE DISCLOSURE

According to Patent Document 1, the main phase is covered with the specific secondary phase to thereby provide the magnet having increased coercivity after heat treatment. However, the magnet of Patent Document 1 includes the secondary phase, so that the ratio of the main phase in the magnet is low, resulting in lowered remanence.

The present disclosure has been made in view of such a problem, and an object thereof is to provide a Sm—Fe—N magnet having high coercivity and high remanence.

To address the problem, a Sm—Fe—N magnet according to an aspect of the present disclosure includes: first crystal grains containing samarium, iron, and nitrogen and having a samarium content of 9 atomic % or more and less than 13 atomic %; and second crystal grains having a samarium content of 13 atomic % or more, wherein, in the second crystal grains, a first average distance between adjacent grains at a cumulative frequency of 50% is 7 μm or less, and a second average distance between adjacent grains at a cumulative frequency of 90% is 12 μm or less.

The present disclosure provides a Sm—Fe—N magnet having high coercivity and high remanence.

### BRIEF DESCRIPTION OF DRAWINGS

FIG. 1A is an example of an SEM image (magnification: 2000×) used for segmentation.

FIG. 1B is an example of an SEM image obtained by binarizing FIG. 1A and illustrating the first crystal grains (main phase) in black.

FIG. 1C is an example of an SEM image obtained by binarizing FIG. 1A and illustrating grain boundaries between the first crystal grains and the second crystal grains in black.

FIG. 2 illustrates a method for calculating distances between adjacent grains.

FIG. 3 is an SEM image (magnification: 2000×) of a section of a sintered magnet obtained in Example 1.

FIG. 4 is an SEM image (magnification: 2000×) of a section of a sintered magnet obtained in Comparative Example 1.

FIG. 5 is an SEM image (magnification: 2000×) of a section of a sintered magnet obtained in Comparative Example 2.

### DESCRIPTION OF THE PREFERRED EMBODIMENTS

A Sm—Fe—N magnet (samarium-iron-nitrogen magnet) according to the present disclosure includes first crystal grains containing samarium, iron, and nitrogen and having a samarium content of 9 atomic % or more and less than 13 atomic %. The Sm—Fe—N magnet according to the present disclosure further includes second crystal grains having a samarium content of 13 atomic % or more (hereafter also referred to as Sm-rich crystal grains).

The first crystal grains containing samarium, iron, and nitrogen (hereafter also referred to as Sm—Fe—N crystal grains) refer to grains having a Sm—Fe—N crystal structure. The second crystal grains are crystal grains containing samarium oxide (not containing iron or nitrogen) or crystal grains containing samarium, iron, and nitrogen.

The first crystal grains form the main phase of the Sm—Fe—N magnet. The first crystal grains are a target material when synthesizing Sm—Fe—N crystal grains (an alloy containing samarium, iron, and nitrogen). In contrast, the Sm-rich crystal grains are by-products that are inevitably generated when synthesizing the alloy containing samarium, iron, and nitrogen. The inevitably generated Sm-rich crystal grains that are in a specific distribution state have been found to provide improved coercivity.

Specifically, in a distribution of average distances between adjacent grains of the second crystal grains in the magnet of the present disclosure, an average distance D50 between adjacent grains at a cumulative frequency of 50% is 7 μm or less, and an average distance D90 between adjacent grains at a cumulative frequency of 90% is 12 μm or less. In other words, for 50% of the Sm-rich crystal grains on a number basis, other Sm-rich crystal grains exist within an average distance of 7 μm, and for 90% of the Sm-rich crystal grains on a number basis, other Sm-rich crystal grains exist within an average distance of 12 μm. This indicates that the Sm-rich crystal grains are not unevenly distributed but are uniformly dispersed in the magnet.

The reason why the magnet has improved coercivity when the Sm-rich crystal grains are uniformly dispersed in the magnet is inferred as described below. Note that when the Sm-rich crystal grains are uniformly dispersed in the magnet, the Sm-rich crystal grains can be regarded as uniformly dispersed also in precursors of the magnet (for example, magnets after molding and before sintering or before curing).

When producing a magnet from Sm—Fe—N crystal grains and the like (here, at least the first and second crystal grains), heat treatment may be performed. For example, during sintering or curing, heat treatment may be performed. In this case, an oxidation-reduction reaction occurs in which an oxide of Sm is formed, and α-type iron (a-Fe) may precipitate. α-Fe is soft magnetic, and a magnet containing α-Fe tends to undergo coercivity degradation. However, when the Sm-rich crystal grains are uniformly dispersed in the precursor of the magnet, Fe can easily react, before precipitation, with Sm abundantly contained in the Sm-rich crystal grains. As a result, precipitation of α-Fe is suppressed. Therefore, a magnet produced in the presence of the Sm-rich crystal grains can have high coercivity.

In the present disclosure, as described above, the distribution state of the inevitably generated Sm-rich crystal grains is controlled, to thereby avoid the decrease in the ratio of the main phase in the magnet. Therefore, inherently high remanence of the Sm—Fe—N magnet can be maintained, and the resulting magnet also has high remanence.

The distribution state of the Sm-rich crystal grains can be controlled by, for example, pulverization conditions when synthesizing Sm—Fe—N crystal grains. The pulverization conditions will be described later.

The average distance D50 between adjacent grains at a cumulative frequency of 50% (hereafter also simply referred to as “adjacent-grain distance D50”) of the Sm-rich crystal grains may be 6.5 μm or less, may be 6.3 μm or less, or may be 5.4 μm or less. The adjacent-grain distance D50 may be 3.0 μm or more, may be 3.5 μm or more, or may be 4.0 μm or more.

The average distance D90 between adjacent grains at a cumulative frequency of 90% (hereafter also simply referred to as “adjacent-grain distance D90”) of the Sm-rich crystal grains may be 11.5 μm or less or may be 11.3 μm or less. The adjacent-grain distance D90 may be 5.0 μm or more or may be 8.0 μm or more.

The magnet according to the present disclosure includes at least the above-described first and second crystal grains. The Sm—Fe—N magnet may include other materials, for example, α-Fe and trace elements inevitably mixed therein.

The magnet may be a bonded magnet or may be a sintered magnet. The magnet may be a sintered magnet. The sintered magnet is obtained by sintering Sm—Fe—N crystal grains and the like at high temperature. The Sm—Fe—N magnet that is a sintered magnet according to the present disclosure can be composed substantially of a sintered body of the first crystal grains and the second crystal grains. In the precursor of the magnet (the magnet after molding and before sintering), the Sm-rich crystal grains are also uniformly dispersed, so that precipitation of α-Fe in the sintering step can be effectively suppressed.

### Method for Identifying Crystal Grains

The first and second crystal grains can be identified as follows.

First, an elemental distribution in a section of the magnet is obtained by an energy-dispersive X-ray (EDX) analysis method. The elemental distribution is typically measured using an SEM-EDX analysis apparatus.

The EDX analysis is performed, for example, under the following conditions.

TABLE 1

| EDX apparatus | HORIBA, Ltd., EMAX-Evolution | |
|---|---|---|
| Accelerating voltage | 15 | kV |
| Emission | 10 | μA |
| WD (working distance) | 15 | mm |
| signal | SE (L) | |
| Magnification | 5k | |
| Tilt | None | |
| Pre-treatment | Milling and Pt coating | |
| Process time | 5 | |
| Frames | 100 | |
| Dwell Time | 100 | μs |
| Pixel count | 256 | dpi |

| | |
|---|---|
| Type | TruMAP |

An image obtained using an SEM (scanning electron microscope) and used for EDX analysis can be obtained, for example, under the following conditions.

TABLE 2

| | |
|---|---|
| SEM apparatus | Hitachi, Ltd., SU8000 |
| Accelerating voltage | 5 kV (WD: 4100 μm) |
| Detector | LA-BSE (for composition-sensitive backscattered- |
| | electron imaging) |
| Pixel count | 2560 × 1920 (resolution: 0.0248 μm/pix) |
| Number of fields | 4 |
| Image format | BMP |

Subsequently, based on the elemental distribution obtained by SEM-EDX analysis, a region having a samarium atomic content of 13 atomic % or more (corresponding to the second crystal grains (Sm-rich crystal grains)) and a region having a samarium atomic content of 9 atomic % or more and less than 13 atomic % (corresponding to the first crystal grains) are segmented. As a result of segmentation, grain boundaries between the first and second crystal grains are determined and the first and second crystal grains are identified.

The segmentation can be performed by processing the above SEM image using deep-learning image-processing software (for example, “MIPAR 3.4” manufactured by Lightstone Corp.). Specific procedures of this method are as follows.

TABLE 3

| | Segmentation procedures |
|---|---|
| Image | MIPAR Image Processor |
| preprocessing | Remove noise (median filter → non-local means). |
| | Normalize image contrast (brightness/levels/gamma |
| | correction/background flattening). |
| Deep learning | MIPAR Deep Learning Trainer |
| | Perform Training using, as training data, four |
| | homogeneous SEM images in which main-phase grains |
| | and secondary-phase grains have been predefined. |
| | Tiles: 5 × 5; Epochs: 700 |
| | Augment the training set by left-right flip/up-down |
| | flip/180° rotation of the images. |
| Segmentation | MIPAR Image Processor |
| | Apply the trained model obtained by deep learning to |
| | the SEM image to perform segmentation. |
| | As needed, perform segmentation using the Watershed |
| | method, the Segment Anything Model (SAM) method, or |
| | manual editing. |
| | Remove small noise particles (by thresholding on area, |
| | equivalent circular diameter, aspect ratio, and perimeter). |
| | Remove particles at image edges. |
| | Output shape/size information using the Measurement |
| | Features function. |

The segmentation may also be performed by binarizing the above SEM image. Specific procedures of this method are as follows.

TABLE 4

| | Segmentation procedures |
|---|---|
| Image | MIPAR Image Processor |
| preprocessing | Remove noise (median filter → non-local means). |
| | Normalize image contrast (brightness/levels/gamma |
| | correction/background flattening). |
| Contrast- | MIPAR Image Processor |
| based | Extract the bright-contrast phase as the Sm-rich |
| segmentation | phase (Basic Threshold). |
| | Remove small noise particles (by thresholding on area, |
| | equivalent circular diameter, aspect ratio, and perimeter). |
| | Remove particles at image edges. |
| | Output shape/size information using the Measurement |
| | Features function. |

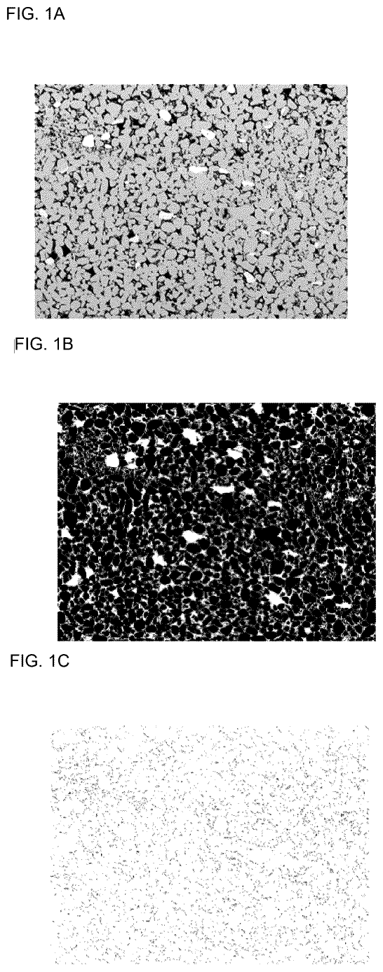

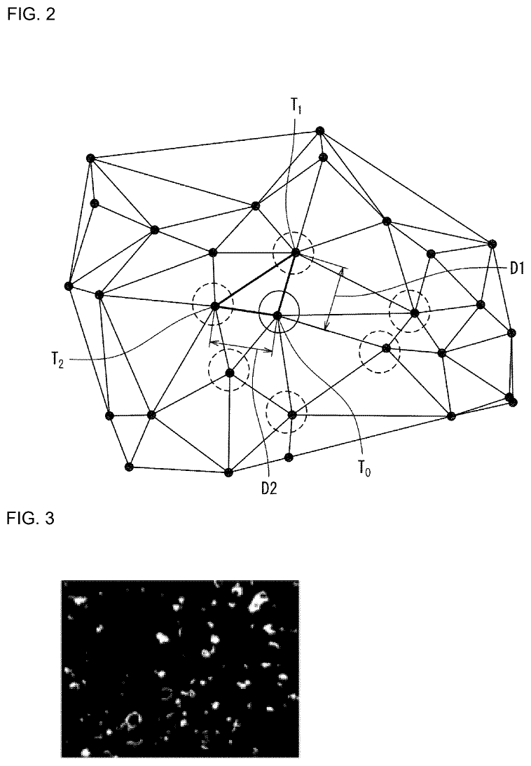

FIG. 1A is an example of an SEM image (magnification: 2000×) used for segmentation. FIG. 1B is an example of an SEM image obtained by binarizing FIG. 1A and illustrating the first crystal grains (main phase) in black. FIG. 1C is an example of an SEM image obtained by binarizing FIG. 1A and illustrating grain boundaries between the first crystal grains and the second crystal grains in black.

### Distance Between Adjacent Grains

The distance between adjacent grains can be obtained by performing Delaunay triangulation on a section of a magnet. First, the centroids of a plurality of Sm-rich crystal grains identified by the above segmentation are regarded as points, and these points are treated as a set of points discretely distributed on a plane. This set of points is subjected to Delaunay triangulation.

Subsequently, as illustrated in FIG. 2, any one vertex T0 is selected from the plurality of Delaunay triangles. The vertex T0 is also the centroid of one Sm-rich crystal grain (reference grain P1; reference sign not shown in the figure). The two other vertices T1 and T2 of the Delaunay triangle including the vertex T0 are also the centroids of two other Sm-rich crystal grains that are adjacent (neighboring) to the reference grain P1. A distance D1 of a line segment connecting the vertex T0 and the vertex T1 represents the distance (distance between adjacent grains) between the reference grain P1 and another Sm-rich crystal grain adjacent (neighboring) to the reference grain P1. Similarly, a distance D2 of a line segment connecting the vertex T0 and the vertex T2 represents the distance (distance between adjacent grains) between the reference grain P1 and still another Sm-rich crystal grain adjacent (neighboring) to the reference grain P1. There are a plurality of Delaunay triangles including the vertex T0. For all Delaunay triangles including the vertex T0, distances D of line segments connecting the vertex T0 and other vertices TX (reference sign not shown in the figure; points surrounded by broken lines) are determined, and the distances D are averaged. The distance D is determined as an average distance Dave between adjacent grains, as measured between the reference grain P1 and the plurality of Sm-rich crystal grains adjacent to the reference grain P1.

Subsequently, all other Sm-rich crystal grains are used as reference grains and subjected to operations similar to those for the reference grain P1 to determine an average distance Dave between adjacent grains, as measured between each Sm-rich crystal grain and other Sm-rich crystal grains adjacent (neighboring) thereto. The plurality of determined average distances Dave between adjacent grains are converted into a histogram to obtain a frequency distribution of the average distances Dave. In the frequency distribution of the average distances Dave, an average distance D50 between adjacent grains at a cumulative frequency of 50% and an average distance D90 between adjacent grains at a cumulative frequency of 90% are determined.

### First Crystal Grains

The first crystal grains form the main phase of the magnet. The first crystal grains are Sm—Fe—N crystal grains and have a samarium content of 9 atomic % or more and less than 13 atomic %. Examples of the crystal structure of the first crystal grains include a SmFe₉N_{1.5} structure and a Sm₂Fe₁₇N₃ structure; however, the crystal structure is not limited thereto and may be any crystal structure composed of Sm, Fe, and N. A typical crystal structure of the first crystal grains is a Sm₂Fe₁₇N₃ structure.

The average grain size of the first crystal grains is not particularly limited. The average grain size of the first crystal grains may be, for example, 0.04 μm to 5 μm. When the average grain size of the first crystal grains is 0.04 μm or more, a transition of the Sm—Fe—N crystal grains to a superparamagnetic state can be effectively suppressed. When the average grain size of the first crystal grains is 5 μm or less, coercivity can be effectively improved.

The method for calculating the average grain size of the first crystal grains is as follows. First, a section of the magnet is photographed using a field emission scanning electron microscope (FE-SEM) so as to include at least a total of 50 or more crystal grains. The first and second crystal grains in the photographed image are identified in the same manner as described above. Subsequently, a total area A1 of sections of the first crystal grains and a number N1 of the crystal grains in the photographed image are determined. A1/N1 is used as the average sectional area per first crystal grain and the square root of the average sectional area al is calculated to determine the average grain size of the first crystal grains.

### Second Crystal Grains

The second crystal grains have a samarium content of 13 atomic % or more. The second crystal grains are samarium oxide (Sm₂O₃) or Sm—Fe—N crystal grains. The samarium content of the second crystal grains may be 14 atomic % or less. Examples of the crystal structure of the second crystal grains that are Sm—Fe—N crystal grains include a Sm₅Fe₁₇N structure and a SmFe₃N structure; however, the crystal structure is not limited thereto and may be any crystal structure composed of Sm, Fe, and N. The second crystal grains are uniformly dispersed in the magnet.

The average grain size of the second crystal grains may be 0.2 μm to 1 μm. When small second crystal grains having an average grain size of 0.2 μm to 1 μm are uniformly dispersed in the magnet, coercivity can be further improved. The average grain size of the second crystal grains may be 0.95 μm or less, may be 0.90 μm or less, or may be 0.86 μm or less. The average grain size of the second crystal grains may be 0.70 μm or more, may be 0.75 μm or more, or may be 0.76 μm or more.

The average grain size of the second crystal grains can also be calculated, as with the average grain size of the first crystal grains, from a total area A2 of sections of the second crystal grains and a number N2 of the crystal grains in the photographed image.

In a section of the magnet, the ratio of the total area of the second crystal grains to the total area of the first crystal grains may be, for example, 2% to 10%. When the area ratio of the second crystal grains is 2% or more, the effect of improving coercivity is easily obtained. When the area ratio of the second crystal grains is 10% or less, the decrease in remanence is suppressed.

The area ratio of the second crystal grains is obtained from the total area A2 of the sections of the second crystal grains and the total area A1 of the sections of the first crystal grains, which are obtained in the same manner as in the case of determining the average grain sizes of the first and second crystal grains, by the formula 100×A2/A1 (%).

100×A2/A1(%) may be 3% or more, may be 3.5% or more, may be 4.0% or more, or may be 5.0% or more. 100×A2/A1(%) may be 9.0% or less or may be 8.0% or less.

### Production Method

Hereinafter, an example of a method for producing a sintered magnet will be described.

First, a Sm—Fe—N magnet coarse powder serving as the raw material is pulverized. The pulverization is performed under appropriate conditions, so that the adjacent-grain distance D50 can be made 7 μm or less and the adjacent-grain distance D90 can be made 12 μm or less.

The Sm—Fe—N magnet coarse powder is pulverized, for example, by repeating a cycle of pulverization treatment and classification a plurality of times. As a result, Sm-rich crystal grains contained in the Sm—Fe—N magnet coarse powder are pulverized more finely and are dispersed more uniformly, and the adjacent-grain distances D50 and D90 are more likely to fall within the above ranges.

The pulverization treatment may be performed, for example, at a pulverization pressure of 0.3 MPa to 1.2 MPa. The pulverization pressure may be 0.5 MPa or more, may be 0.6 MPa or more, or may be 0.7 MPa or more. The pulverization pressure may be 1.0 MPa or less or may be 0.9 MPa or less. The number of cycles may be, for example, 2 or more, may be 3 or more, or may be 4 or more.

The pulverization may be performed using, for example, a jet mill (airflow pulverization type or the like) or a ball mill. The airflow pulverization type jet mill may be, for example, an MC44 manufactured by Micromacinazione.

The pulverization is preferably performed in a glove box replaced with an inert gas (one kind or a mixed gas of two or more kinds of nitrogen, argon, helium, and the like). The pulverization may be performed in a glove box connected to a gas circulation type oxygen and moisture purifier.

In the powder after pulverization, fine powder (corresponding to grains having extremely small grain sizes in the grain size distribution of the powder) has a higher proportion of grains damaged by pulverization and has lower crystallinity than larger grains. In order to obtain pulverized powder having good crystallinity, such fine powder having low crystallinity may be removed by classification. The removal of fine powder can be performed using an airflow classifier or the like, but is not limited thereto. The removed fine powder may be grains having a grain size of less than 0.04 μm, for example.

Subsequently, the mixture including the first crystal grains and the second crystal grains is pressure-sintered. This provides a sintered magnet.

Prior to the pressure sintering, the mixture may be subjected to an orientation step and a magnetization step. As a result, directions of easy magnetization axes of the crystal grains are aligned, and higher magnetic characteristics can be obtained. The applied magnetic field may be a static magnetic field of, for example, 2 T or more.

The pressure-sintering is performed, for example, under an atmosphere having a low oxygen concentration. The pressure-sintering can be performed by any pressure-sintering method including spark plasma sintering. The pressure-sintering may be performed, for example, by filling a die with magnet powder, installing the die, without exposing the die to the atmosphere, in a pulsed electric-current sintering machine equipped with a pressure mechanism using a servo-controlled press device, subsequently applying a constant pressure to the die while maintaining vacuum in the pulsed electric-current sintering machine, and then performing electric-current sintering while maintaining the pressure. The die used may have any shape and may be, for example, cylindrical, but is not limited thereto. The inside of the pulsed electric-current sintering machine is maintained at, for example, a vacuum of 5 Pa or less. The applied pressure may be any pressure that is higher than atmospheric pressure and enables formation of a sintered magnet, and may be, for example, in a range of 100 MPa to 2000 MPa. The electric-current sintering is performed at, for example, a temperature of 400° C. to 600° C. and for a time of 30 seconds to 10 minutes.

The method for producing the mixture including the first and second crystal grains is not limited to the above-described method, and any appropriate method can be used.

The method for producing the magnet is not limited to the above-described method, and any appropriate method can be used.

### EXAMPLES

Examples 1 to 4 and Comparative Examples 1 and 2

The following procedures were carried out to produce Sm—Fe—N sintered magnets.

As the magnet powder raw material, a coarse powder having a composition of Sm₂Fe₁₇N₃ and an average grain size of about 25 μm was prepared. Using an airflow pulverization type jet mill, the prepared coarse powder was pulverized under different conditions. The pulverization conditions will be described in the following Table.

TABLE 5

| | Pulverization | Number |
|---|---|---|
| | pressure (MPa) | of cycles |
| Example 1 | 0.7 | 2 |
| Example 2 | 0.9 | 2 |
| Example 3 | 0.5 | 4 |
| Example 4 | 0.7 | 2 |
| Comparative Example 1 | 0.7 | 2 |
| Comparative Example 2 | 0.7 | 2 |

The pulverization was performed in a glove box under a low-oxygen atmosphere. After the pulverization, an airflow classifier was used to remove fine powder (grains having a grain size of less than 0.04 μm). This provided Sm—Fe—N crystal grains.

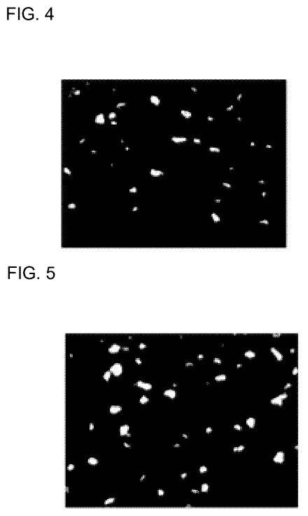

0.5 g of the obtained Sm—Fe—N crystal grains was weighed and filled into a cylindrical die made of cemented carbide and having an inner diameter of 6 mm. The die was installed, without being exposed to the atmosphere, in a pulsed electric-current sintering machine equipped with a pressure mechanism using a servo-controlled press device. Subsequently, while keeping the inside of the pulsed electric-current sintering machine at a vacuum of 2 Pa or less and at an oxygen concentration of 0.4 ppm or less, a pressure of 1200 MPa was applied, and electric-current sintering was performed for 2 minutes at a sintering temperature of 500° C. while maintaining the pressure; in this way, sintered magnets were obtained. SEM images of sections of the sintered magnets are illustrated in FIGS. 3 to 5. In the SEM images, portions illustrated in light gray are the second crystal grains, and portions illustrated in black or dark gray are the first crystal grains.

### Evaluation

The obtained sintered magnets were evaluated as follows. The evaluation results will be described in the following table.

### (1) Average Grain Sizes of Crystal Grains, A2/A1

An SEM image of a section of such a sintered magnet was photographed, and the first and second crystal grains in the photographed image were identified by the method using the above deep-learning image-processing software (“MIPAR 3.4” manufactured by Lightstone Corp.). The total area A1 and the number N1 of sections of the first crystal grains and the total area A2 and the number N2 of sections of the second crystal grains in the photographed image were determined, and the average grain sizes of the crystal grains and A2/A1 were calculated in the same manner as described above.

### (2) Average Distances D50 and D90 Between Adjacent Grains

An SEM image of a section of such a sintered magnet was subjected to Delaunay triangulation, the average values of distances between adjacent grains were calculated in the same manner as described above, and the values were converted into a histogram.

### (3) Remanence and Coercivity

Remanence and coercivity were measured using a vibrating sample magnetometer (VSM).

TABLE 6

| | Example | Example | Example | Example | Comparative | Comparative |
|---|---|---|---|---|---|---|
| | 1 | 2 | 3 | 4 | Example 1 | Example 2 |
| Average grain size of | 0.74 | 0.52 | 0.65 | 0.56 | 0.44 | 0.59 |
| first crystal grains (μm) | | | | | | |
| Average grain size of | 0.84 | 0.76 | 0.86 | 0.81 | 0.99 | 1.49 |
| second crystal grains (μm) | | | | | | |
| Adjacent-grain distance | 6.3 | 5.4 | 4.5 | 5.0 | 8.6 | 8.1 |
| D50 (μm) | | | | | | |
| Adjacent-grain distance | 10.6 | 11.3 | 8.7 | 8.3 | 1.8 | 13.9 |
| D90 (μm) | | | | | | |
| A2/A1 (%) | 3.5 | 5.6 | 8.0 | 6.4 | 3.2 | 4.5 |
| Remanence (T) | 0.99 | 0.98 | 0.99 | 0.97 | 1.00 | 0.99 |
| Coercivity (kA/m) | 951 | 1027 | 956 | 1053 | 887 | 826 |

The sintered magnet and magnet powder of the present disclosure can be used in a wide range of applications in fields of various motors. For example, the sintered magnet and the magnet powder can be used in auxiliary on-board motors, main motors for EV/HEV, and the like and can be used more specifically in oil-pump motors, electric power steering motors, EV/HEV drive motors, and the like.

### REFERENCE SIGNS LIST

T0 one of the vertices of a Delaunay triangle and centroid of reference grain P1
T1 another one of the vertices of the Delaunay triangle and centroid of another Sm-rich crystal grain adjacent (neighboring) to the reference grain P1
T2 still another one of the vertices of the Delaunay triangle and centroid of still another Sm-rich crystal grain adjacent (neighboring) to the reference grain P1
D1 distance of a line segment connecting the vertex T0 and the vertex T1
D2 distance of a line segment connecting the vertex T0 and the vertex T2

1. A Sm—Fe—N magnet comprising:
first crystal grains containing samarium, iron, and nitrogen, and having a samarium content of 9 atomic % or more and less than 13 atomic %; and
second crystal grains having a samarium content of 13 atomic % or more,
wherein, in the second crystal grains:
a first average distance between adjacent grains at a cumulative frequency of 50% is 7 μm or less, and
a second average distance between adjacent grains at a cumulative frequency of 90% is 12 μm or less.

2. The Sm—Fe—N magnet according to claim 1, wherein the second crystal grains have an average grain size of 0.2 μm to 1 μm.

3. The Sm—Fe—N magnet according to claim 1, wherein the first crystal grains have an average grain size of 0.04 μm to 5 μm.

4. The Sm—Fe—N magnet according to claim 1, wherein the first average distance between the adjacent grains at the cumulative frequency of 50% is 3.0 μm to 6.5 μm.

5. The Sm—Fe—N magnet according to claim 4, wherein the second average distance between the adjacent grains at the cumulative frequency of 90% is 5.0 μm to 11.5 μm.

6. The Sm—Fe—N magnet according to claim 1, wherein the second average distance between the adjacent grains at the cumulative frequency of 90% is 5.0 μm to 11.5 μm.

7. The Sm—Fe—N magnet according to claim 1, wherein the second crystal grains comprise samarium oxide.

8. The Sm—Fe—N magnet according to claim 1, wherein in a section of the Sm—Fe—N magnet, a ratio of a total area of the second crystal grains to a total area of the first crystal grains is 2% to 10%.

9. The Sm—Fe—N magnet according to claim 1, wherein the first crystal grains and the second crystal grains are included in a sintered body.

10. A Sm—Fe—N magnet comprising:
first crystal grains containing samarium, iron, and nitrogen, and having a samarium content of 9 atomic % or more and less than 13 atomic %; and
second crystal grains having a samarium content of 13 atomic % or more, wherein, in the second crystal grains, an average distance between adjacent grains at a cumulative frequency of 50% is 7 μm or less.

11. The Sm—Fe—N magnet according to claim 10, wherein the second crystal grains have an average grain size of 0.2 μm to 1 μm.

12. The Sm—Fe—N magnet according to claim 10, wherein the first crystal grains have an average grain size of 0.04 μm to 5 μm.

13. The Sm—Fe—N magnet according to claim 10, wherein the average distance between the adjacent grains at the cumulative frequency of 50% is 3.0 μm to 6.5 μm.

14. The Sm—Fe—N magnet according to claim 10, wherein the second crystal grains comprise samarium oxide.

15. The Sm—Fe—N magnet according to claim 10, wherein in a section of the Sm—Fe—N magnet, a ratio of a total area of the second crystal grains to a total area of the first crystal grains is 2% to 10%.

16. The Sm—Fe—N magnet according to claim 10, wherein the first crystal grains and the second crystal grains are included in a sintered body.
